(19) United States
(12) Patent Application Publication
(10) Pub. No.: US 2012/0066625 A1
(43) Pub. Date: Mar. 15, 2012

(54) SCIENTIFIC RESEARCH AND COLLABORATION SYSTEM AND METHOD

(76) Inventors: Nicolas Encina, Charlestown, MA (US); Brian Gilman, Brookline, MA (US)

(21) Appl. No.: 13/105,744

(22) Filed: May 11, 2011

Related U.S. Application Data
(60) Provisional application No. 61/333,940, filed on May 12, 2010.

(51) Int. Cl. G06F 3/048

(52) U.S. Cl. 715/765

(57) ABSTRACT

Disclosed is a scientific collaboration apparatus that in one general aspect includes a user-configurable workspace and a communication interface operative to communicate with a computer network. The invention also features a scientific information processing tool library that includes a selection interface responsive to a user selection of ones of a plurality of scientific information processing tools that include: one or more scientific data management tools, which are operative to manage scientific data annotated with research identifying meta-data, and one or more scientific data communication tools, which are operative to communicate the research identifying meta-data with communication tools in other user-configurable workspaces via the communication interface. A workspace design interface is provided as well, and it is responsive to user input to assemble a series of the scientific information processing tools from the scientific information processing tool library in the user-configurable workspace. It is operative to organize user interface elements associated with the tools in the user-configurable workspace, and organize data interfaces between selected ones of the tools.

### CROSS-REFERENCE TO RELATED APPLICATIONS

This application claims the benefit of U.S. Provisional Application No. 61/333,940, filed May 12, 2010 which is herein incorporated by reference.

### FIELD OF THE INVENTION

This invention relates to methods and apparatus that are designed to assist researchers with their research and their collaboration with other researchers.

### BACKGROUND OF THE INVENTION

Electronic laboratory notebooks have been available for some time now. These programs allow researchers to record information relating to scientific experiments electronically, for later retrieval or searching. Scientists have also had access to different types of specialized science-oriented search and data analysis tools that allow searching and analysis in specific areas of science, such as chemistry or molecular biology.

### SUMMARY OF THE INVENTION

In one general aspect, the invention features a scientific collaboration apparatus that includes a user-configurable workspace and a communication interface operative to communicate with a computer network. The invention also features a scientific information processing tool library that includes a selection interface responsive to a user selection of ones of a plurality of scientific information processing tools that include: one or more scientific data management tools, which are operative to manage scientific data annotated with research identifying meta-data, and one or more scientific data communication tools, which are operative to communicate the research identifying meta-data with communication tools in other user-configurable workspaces via the communication interface. A workspace design interface is provided as well, and it is responsive to user input to assemble a series of the scientific information processing tools from the scientific information processing tool library in the user-configurable workspace. It is operative to organize user interface elements associated with the tools in the user-configurable workspace, and organize data interfaces between selected ones of the tools.

In preferred embodiments, the research identifying meta-data can be species identifying meta-data. The research identifying meta-data can be compound-identifying meta-data. The research identifying meta-data can be sequence-identifying meta-data. The research identifying meta-data can be assay-identifying meta-data. The apparatus can further include an automatic sharing update engine responsive to the scientific data annotated with research identifying meta-data and operative to index scientific data by research target. The scientific data management tools can include experiment design tools. The scientific data management tools can include experimental data analysis tools. The scientific information processing tool library can include experimental data acquisition tools. The workspace design interface can be operative to employ one of a plurality of workspace templates. The user-configurable workspace can employ a workspace template configured as an electronic laboratory notebook. The user-configurable workspace can employ a workspace template configured as project management tool suite. The user-configurable workspace can employ a workspace template configured as a scientific browser operative to browse the scientific data based on the research identifying meta-data. The scientific browser can include relationship detection logic that is responsive to the research identifying meta-data in the scientific data and is operative to communicate relationships between data from disparate sources to the user. The scientific data management tools can include a publication tool responsive to user input to publish scientific data with research identifying meta-data. The scientific data management tools can include experimental data visualization tools. The scientific data management tools can include a publication tool responsive to user input to publish scientific data with research identifying meta-data. The workspace design interface can include a visual stream-based authoring interface operative to create relationships between the scientific information processing tools. The apparatus can further include at least one scientific data library operative to communicate with at least one of the scientific data communication tools. The apparatus can further include tagging logic responsive to user selection to aggregate objects into named collections. The apparatus can further include collection-sharing logic operative to share the collections with others. The collection-sharing logic can be operative to share the collections in tabular format. The scientific information processing tool library can include payment logic operative to receive a payment commitment for at least some of the scientific information processing tools. The payment logic can be part of an application store for applications developed by a plurality of different application developers. The scientific information processing tool library can include tools designed according to a predetermined tool design standard. The scientific information processing tool library can include chemistry-specific tools. The scientific information processing tool library can include biology-specific tools. The apparatus can further include communication security logic operative to allow the communication tools to securely communicate the annotated scientific-data with the communication tools in other user-configurable workspaces. At least the user-configurable workspace can be virtualized within a networked computer system.

In another general aspect, the invention features a scientific collaboration apparatus that includes means for communicating with a computer network, and means for configuring a workspace by a user. A scientific information processing tool library means includes a selection interface responsive to a user selection of ones of a plurality of scientific information processing tools that include: one or more scientific data management tools, which are operative to manage scientific data annotated with research identifying meta-data, and one or more scientific data communication tools, which are operative to communicate the research identifying meta-data with communication tools in other user-configurable workspaces via the communication interface. Also includes are means responsive to user input for assembling a series of the scientific information processing tools from the scientific information processing tool library means in the workspace, with the means for assembling including means for organizing user interface elements associated with the tools in the workspace, and means for organizing data interfaces between selected ones of the tools.

In a further general aspect, the invention features a scientific collaboration method that includes providing a communication interface, which is operative to communicate with a computer network and providing a user-configurable workspace. The method also includes providing a scientific information processing tool library that includes a selection interface responsive to a user selection of ones of a plurality of scientific information processing tools that include one or more scientific data management tools, which are operative to manage scientific data annotated with research identifying meta-data, and one or more scientific data communication tools, which are operative to communicate the research identifying meta-data with communication tools in other user-configurable workspaces via the communication interface. Further included in the method are steps of providing a workspace design interface, which is responsive to user input to assemble a series of the scientific information processing tools from the scientific information processing tool library in the user-configurable workspace, with the workspace design interface being operative to organize user interface elements associated with the tools in the user-configurable workspace, and organize data interfaces between selected ones of the tools.

### BRIEF DESCRIPTION OF THE DRAWING

FIG. 1 is a block diagram of an illustrative scientific collaboration system according to the invention;

FIG. 2 is a user interface diagram illustrating views available using the system of FIG. 1;

FIG. 3 is a screenshot of an illustrative portal view for the system of FIG. 1;

FIG. 4 is a screenshot of an illustrative scientific browsing tool view for the system of FIG. 1;

FIG. 5 is a screenshot of an illustrative laboratory notebook view for the system of FIG. 1;

FIG. 6 is a screenshot of an illustrative pipe manipulation view for the system of FIG. 1;

FIG. 7 is a screenshot of an illustrative atlas view for the system of FIG. 1;

FIG. 8 is a screenshot of a labeled collection view for the system of FIG. 1; and

FIG. 9 is a screenshot of filters to customize the view in FIG. 8.

### DETAILED DESCRIPTION OF AN ILLUSTRATIVE EMBODIMENT

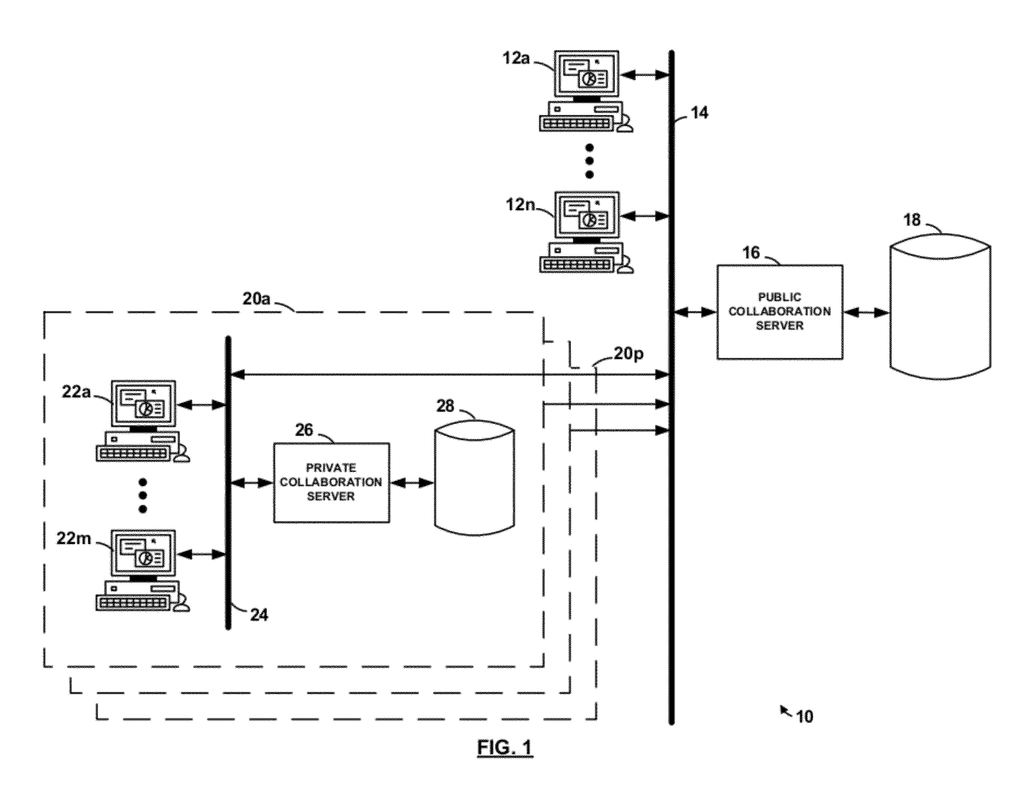

Referring to FIG. 1, an illustrative scientific collaboration system 10 can include a plurality of scientific workstations 12a . . . 12n that communicate with one or more public collaboration servers 16 over a network 14, such as the internet. The public collaboration servers are operatively connected to storage 18, which can include a database.

The system 10 can also include private collaboration domains 20a . . . 20p. These can each include a plurality of scientific workstations 22a . . . 22n that communicate with private collaboration servers 26 over a private network 24, such as a corporate wide-area network (WAN). The private collaboration servers 26 are operatively connected to storage 28, which can include a database. The private collaboration domains can allow different levels of cooperation with other domains or workstations as will be discussed in more detail below.

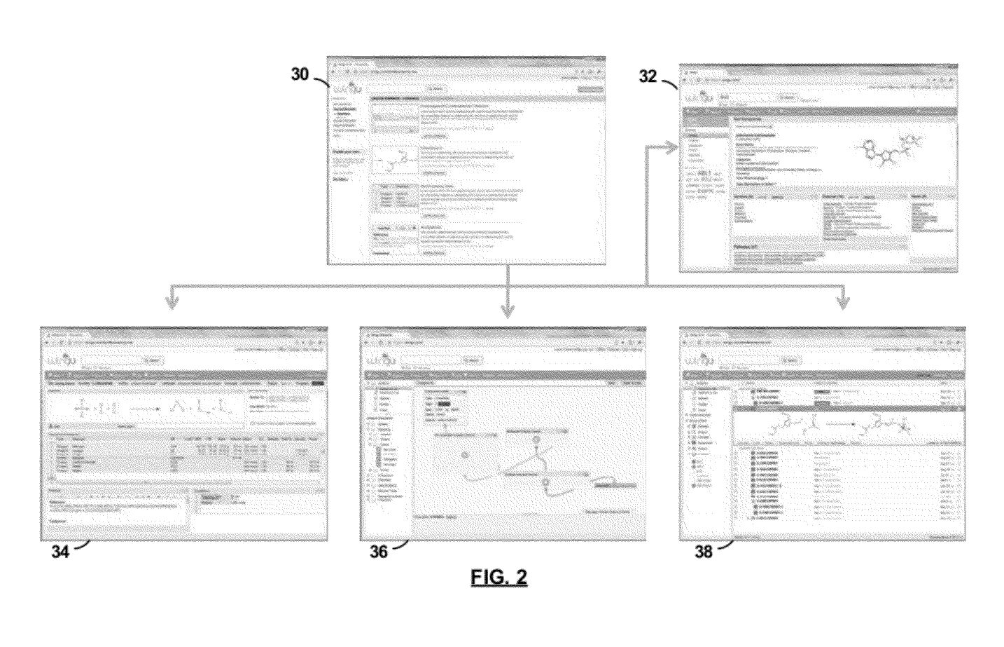

Referring to FIG. 2, the system 10 provides its users with a series of interoperable collaborative views 30, 32, 34, 36, 38. These views are preferably provided by web-based software, such as Asynchronous JavaScript And XML (AJAX), running on one or more general-purpose processors on one or more public or private collaboration servers in a cloud computing environment. This software enables browsers running on the different workstations to efficiently present the different collaborative views to the users. One or ordinary skill in the art would of course recognize that the functionality presented to the users can be provided in other ways, including dedicated hardware, other types of software running on the workstations and/or servers, or a combination of these. And while the system can be broken into the views and modules shown for illustration purposes, one of ordinary skill in the art would recognize that it is also possible to combine them and/or split them differently to achieve a different breakdown. For example, a subset of the functionality shown in one of the views could be presented in a different view instead of, or in addition to, being presented in that view. Different screen arrangements and control metaphors could also be used in the different views.

The views include a scientific collaboration system portal view 30, a scientific browsing tool view 32, a laboratory notebook view 34, a pipe manipulation view 36, and an atlas view 38. In the illustrative system, all of these views are customizable, and they can interact with each other in a variety of ways.

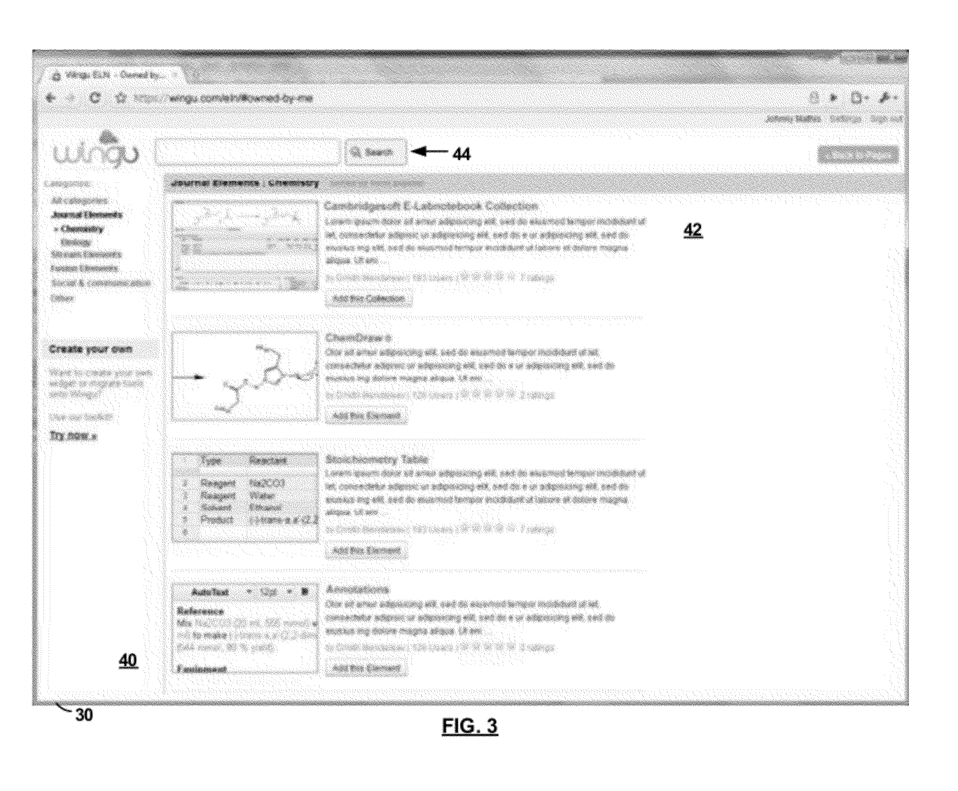

Referring to FIG. 3, the portal view provides a basic starting point for setting up, accessing, and customizing the other views. It can include a hierarchical navigation sidebar 40 and a selection list area 42, as well as a search box 44. Users can select types of views from the sidebar and then select specific views to use within the same type from the selection list area.

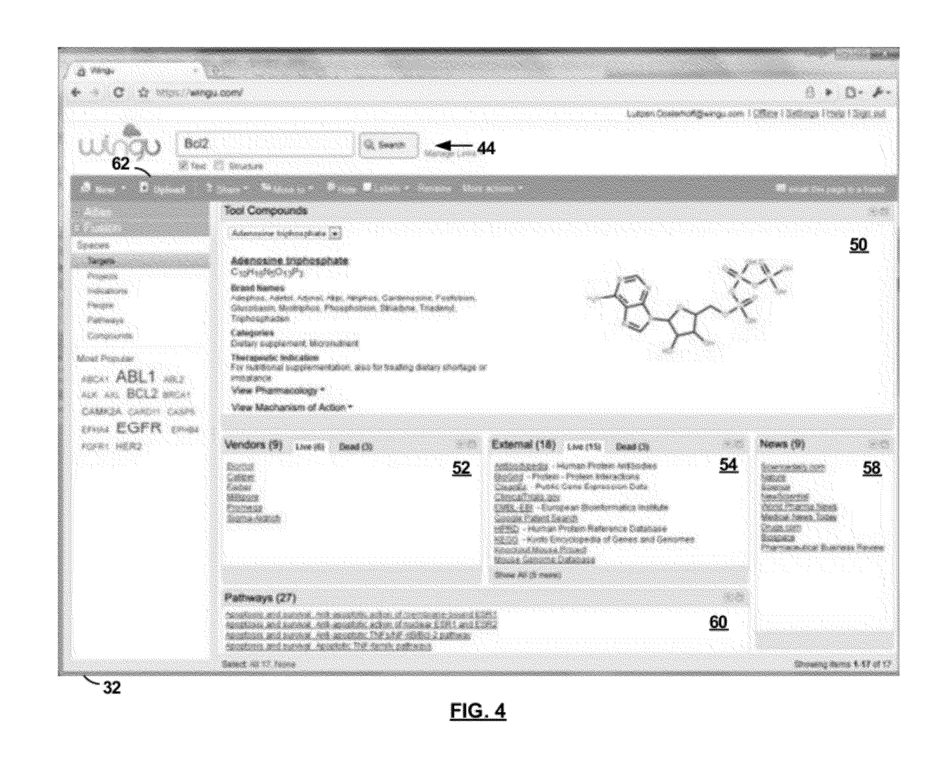

Referring to FIG. 4, the scientific browsing tool view 34 features bidirectional viewing and publication functionality. It includes a set of user-assembled viewing windows, that can include specialized scientific viewing functionality, such as a compound viewing window 50, a vendor window 52, an external viewing window 54, and a scientific news viewing window 60. It also includes an upload control 62 that allows a researcher to upload scientific data so that it can be searched as well. As described in more detail below, data searching through the browsing tool can come from a variety of sources, such as uploads, published sources, pipes, and laboratory notebook view tools.

The scientific browsing tool 32 includes content-aware indexing logic that actively classifies and associates data available to it on an ongoing basis as new content becomes available. Information of different types that relate to a particular compound, for example, can be associated with that compound. The different types of information can include published articles about compound, standard reference material about the compound, vendor source information for the compound, uploaded material about the compound, or experimental designs and results relating to the compound.

The-content-aware indexing logic uses meta-data associated with different sources to make the associations. Synonym tables can also be provided in areas where differences in nomenclature are common. The result is a collaborative environment where a variety of types of information, including collaborative information, are automatically and continuously indexed for the user. Not only can this indexing provide ready access to information in real-time or near-real-time, but it can also act as a guided roadmap through related concepts. Researchers can also program alerts that notify them when the indexing logic finds new content matching particular criteria.

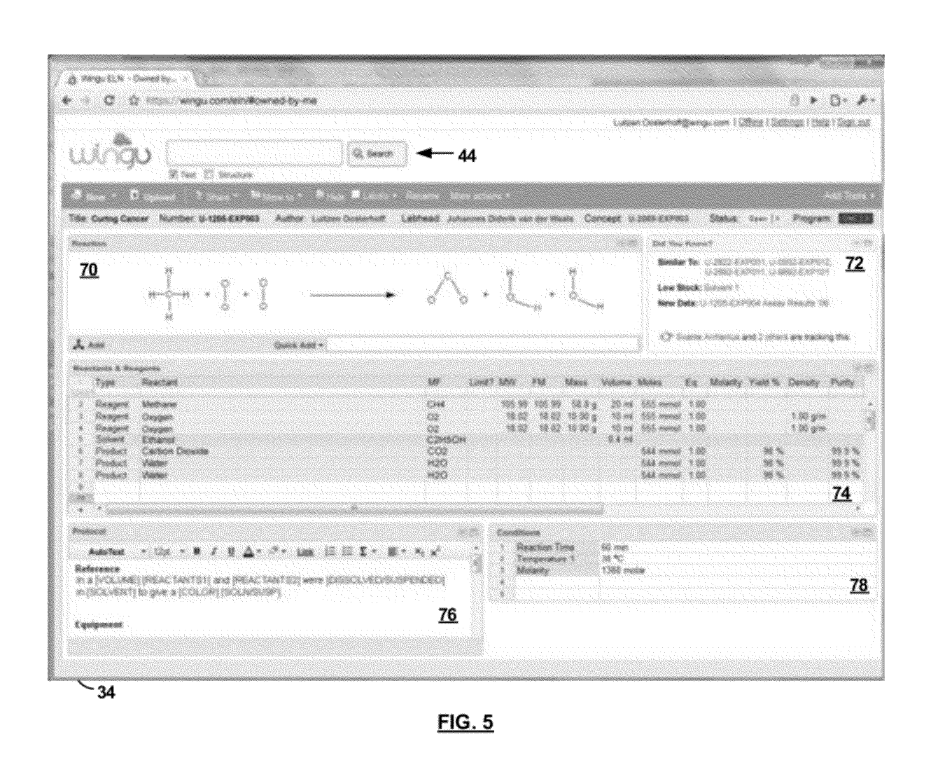

Referring to FIG. 5, the laboratory notebook view 34 is a highly customizable view that allows a researcher to assemble a set of laboratory notebook tools that can help with a variety of aspects of scientific experiments, such as design, documentation, implementation, and/or data logging for an experiment. Illustrative tools can include a reaction tool 70, a related information tool 72, a reactions and reagents analysis tool 74, a protocol tool 76, and a conditions tool 78.

The related information tool 72 performs analytics in real time so that as researchers define experiments using the laboratory notebook view, they will be alerted to time-sensitive information such as similar experiments, reagent conditions, and social networking components. Upstream experimental designs can be linked to downstream data results so that researchers will be informed when data associated with their experiments is generated. Other users interested in “tracking” experiments will also be alerted to promote data sharing and transparency across organizations.

The laboratory notebook view interface is preferably an open interface that allows developers or even users to create new tools. Tools can be shared or provided free of charge. They can also be sold through the system in a tool store view (not shown).

The creation of individual new tools can begin with tool templates to simplify development. Workspace templates can also be included to provide a starting point for laboratory notebook views customized for particular types of experiments.

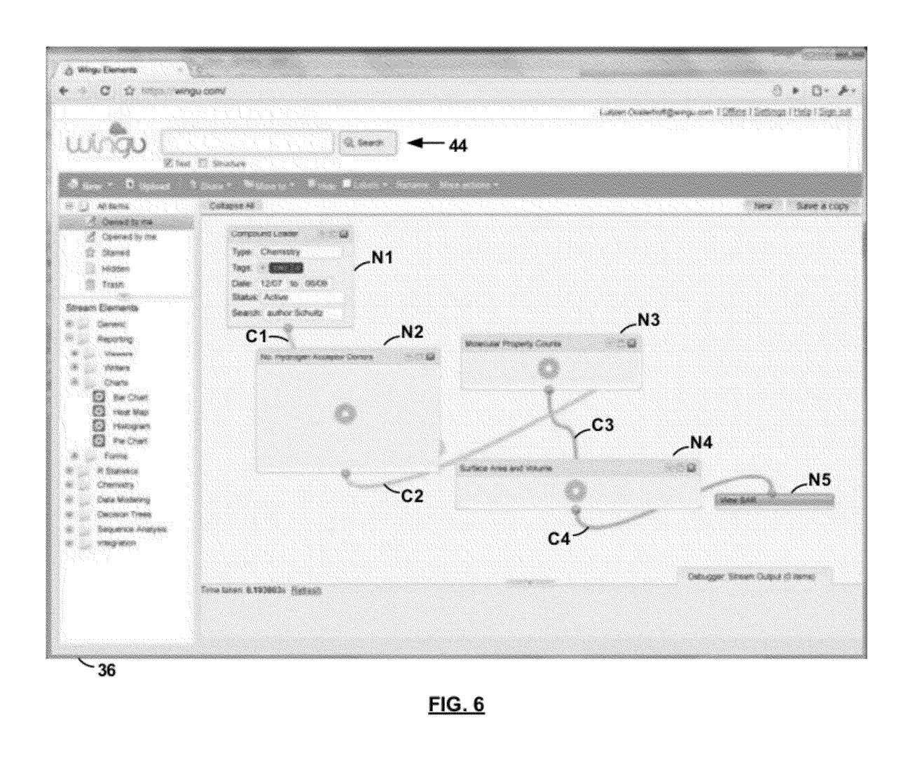

Referring to FIG. 6, the pipe manipulation view 36 allows users to manipulate flows of information in the system 10. It can allow user to produce a particular view of a set of chemical data, such as a SAR table, for example, in a laboratory notebook view tool, but it preferably can also be used to manipulate any other kind of information flow within the system. The pipe manipulation view employs a node-and-connector interface that allows users to perform a succession of different kinds of operations on one or more data elements by visually positioning operation nodes (e.g., N1, N2, N3, N4) and connectors (e.g., C1, C2, C3, C4) in the view.

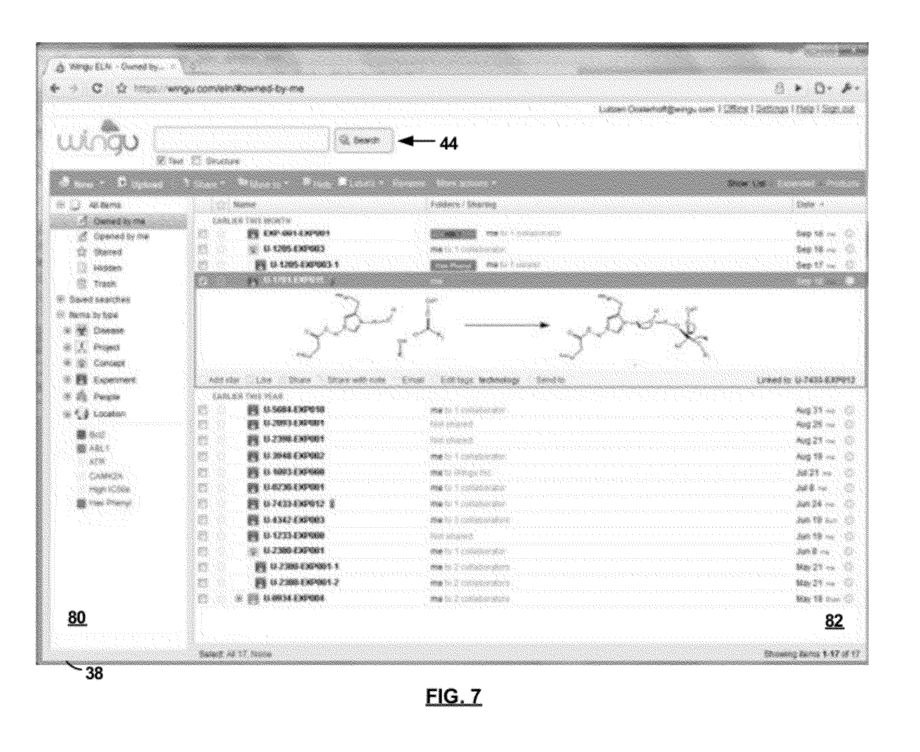

Referring to FIG. 7, the atlas view 38 allows the user to navigate through collections of different experiments. It can include a hierarchical experiment collection navigation sidebar 80, and an expandable, hierarchical experiment listing view 82. This kind of view can be used to access groups of experiments at different levels. At the lowest level, researchers can view one or more groups of their own experiments. Researchers can also access experiments of others, including collaborators and third parties associated with other institutions. At higher levels, specialized group-management views can be provided for group managers, and enterprise-wide management views can be provided for senior management.

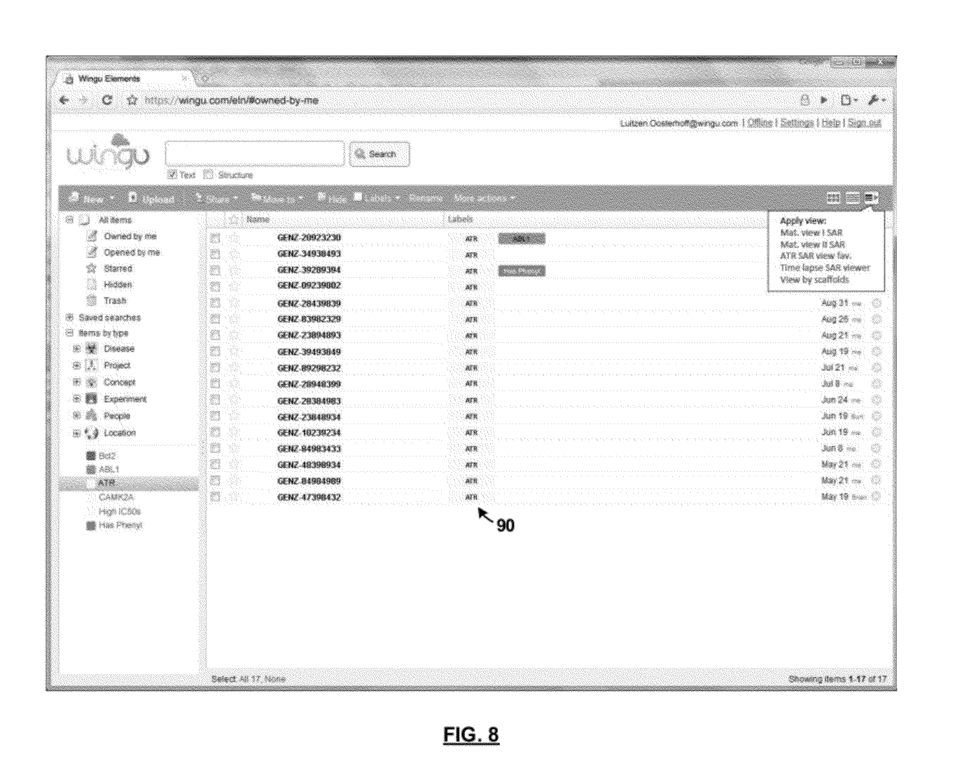

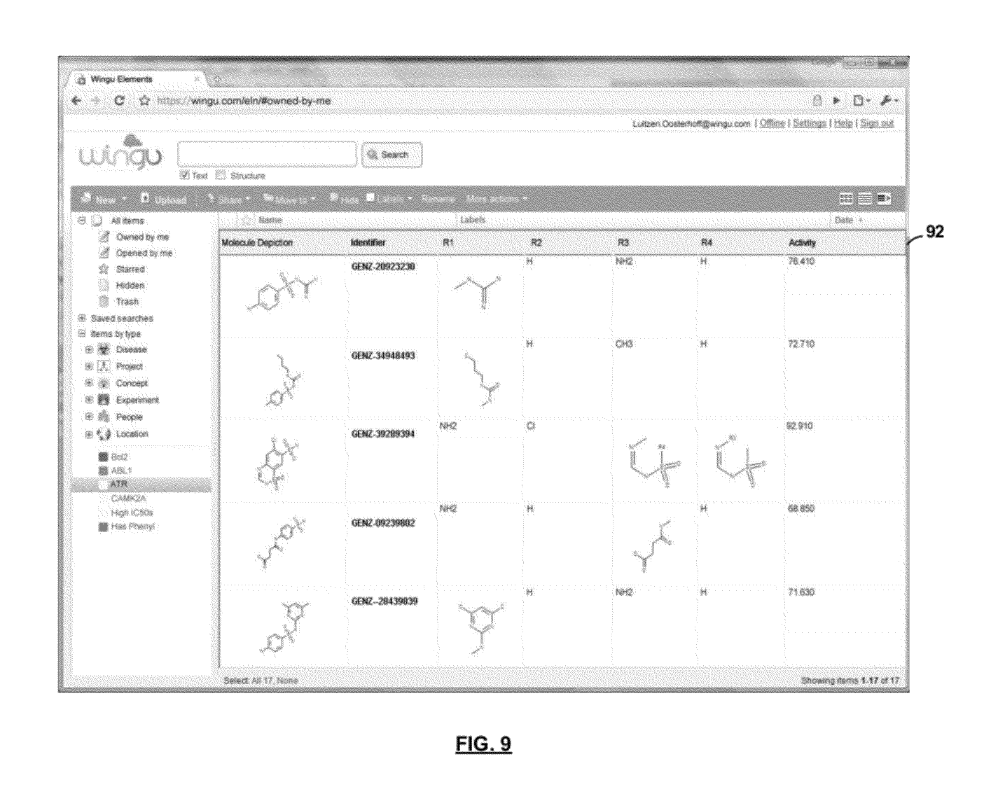

Referring to FIG. 8, labels 90 allow the user to aggregate business objects into named collections. Those labeled collections can then be used in a number of ways from sharing with others, submitting to workflows, to setting notification alerts for any information captured for those objects, among other uses. Additionally, users can publish customized formats and table renderers to apply to those labeled collections so that the data is rendered contextually to specific tasks, as shown in FIG. 9. When applying a view to a collection, the collection will pass unique identifiers that will be used to match with additional data and rendered in specific format, such as the table 92 shown in FIG. 9.

Overall, the system provides a rich cooperative environment in which scientific information is being shared in a meaningful way on an ongoing basis. This allows users to build on the efforts of others and avoid needless repetition of experiments. It can also help direct users to areas of interest by providing a roadmap to different conceptual content areas.

As presented in FIG. 1, systems according to the invention can be deployed publicly to allow researchers to collaborate across institutional boundaries. In some situations, however, such as in the case of commercial product development, private collaborative domains can be set up that allow data to be shared only within an institutional or corporate entity. The separation between domains can be complete, or it can allow some level of interaction. For example, the domain can be configured to receive but not share data, or it can restrict the type of data that can be shared. Even if no external sharing is permitted, larger organizations may still reap significant benefits from the system because it makes information from other business units easily available with little overhead. Absent specific cooperative arrangements between such units, these exchanges might otherwise be quite limited in many corporate settings.

The metadata used by the system 10 can take a variety of forms. Some basic types are generally provided, such as people and projects. Compounds or sequences are also provided, where the system is used for chemical or biochemical research. More complex types can also be provided, such as experimental result types. The metadata can be represented using Extensible Markup Language (XML), JavaScript Object Notation (JSON), or other suitable data interchange formats. Meta-tagging services of different types may also be provided to tag data such as un-indexed scientific papers.

The present invention has now been described in connection with a number of specific embodiments thereof. However, numerous modifications which are contemplated as falling within the scope of the present invention should now be apparent to those skilled in the art. Therefore, it is intended that the scope of the present invention be limited only by the scope of the claims appended hereto. In addition, the order of presentation of the claims should not be construed to limit the scope of any particular term in the claims.

What is claimed is:

1. A scientific collaboration apparatus, comprising:
a communication interface, which is operative to communicate with a computer network,
a user-configurable workspace,
a scientific information processing tool library that includes a selection interface responsive to a user selection of ones of a plurality of scientific information processing tools that include:
one or more scientific data management tools, which are operative to manage scientific data annotated with research identifying meta-data, and
one or more scientific data communication tools, which are operative to communicate the research identifying meta-data with communication tools in other user-configurable workspaces via the communication interface, and
a workspace design interface, which is responsive to user input to assemble a series of the scientific information processing tools from the scientific information processing tool library in the user-configurable workspace, wherein the workspace design interface is operative to:
organize user interface elements associated with the tools in the user-configurable workspace, and
organize data interfaces between selected ones of the tools.

2. The apparatus of claim 1 wherein the research identifying meta-data is species identifying meta-data.

3. The apparatus of claim 1 wherein the research identifying meta-data is compound-identifying meta-data.

4. The apparatus of claim 1 wherein the research identifying meta-data is sequence-identifying meta-data.

5. The apparatus of claim 1 wherein the research identifying meta-data is assay-identifying meta-data.

6. The apparatus of claim 1 further including an automatic sharing update engine responsive to the scientific data annotated with research identifying meta-data and operative to index scientific data by research target.

7. The apparatus of claim 1 wherein the scientific data management tools include experiment design tools.

8. The apparatus of claim 1 wherein the scientific data management tools include experimental data analysis tools.

9. The apparatus of claim 1 wherein the scientific information processing tool library includes experimental data acquisition tools.

10. The apparatus of claim 1 wherein the workspace design interface is operative to employ one of a plurality of workspace templates.

11. The apparatus of claim 10 wherein the user-configurable workspace employs a workspace template configured as an electronic laboratory notebook.

12. The apparatus of claim 10 wherein the user-configurable workspace employs a workspace template configured as project management tool suite.

13. The apparatus of claim 10 wherein the user-configurable workspace employs a workspace template configured as a scientific browser operative to browse the scientific data based on the research identifying meta-data.

14. The apparatus of claim 13 wherein the scientific browser includes relationship detection logic that is responsive to the research identifying meta-data in the scientific data and is operative to communicate relationships between data from disparate sources to the user.

15. The apparatus of claim 14 wherein the scientific data management tools include a publication tool responsive to user input to publish scientific data with research identifying meta-data.

16. The apparatus of claim 1 wherein the scientific data management tools include experimental data visualization tools.

17. The apparatus of claim 1 wherein the scientific data management tools include a publication tool responsive to user input to publish scientific data with research identifying meta-data.

18. The apparatus of claim 1 wherein the workspace design interface includes a visual stream-based authoring interface operative to create relationships between the scientific information processing tools.

19. The apparatus of claim 1 further including at least one scientific data library operative to communicate with at least one of the scientific data communication tools.

20. The apparatus of claim 1 further including tagging logic responsive to user selection to aggregate objects into named collections.

21. The apparatus of claim 20 further including collection-sharing logic operative to share the collections with others.

22. The apparatus of claim 21 wherein the collection-sharing logic is operative to share the collections in tabular format.

23. The apparatus of claim 1 wherein the scientific information processing tool library includes payment logic operative to receive a payment commitment for at least some of the scientific information processing tools.

24. The apparatus of claim 23 wherein the payment logic is part of an application store for applications developed by a plurality of different application developers.

25. The apparatus of claim 1 wherein the scientific information processing tool library includes tools designed according to a predetermined tool design standard.

26. The apparatus of claim 1 wherein the scientific information processing tool library includes chemistry-specific tools.

27. The apparatus of claim 1 wherein the scientific information processing tool library includes biology-specific tools.

28. The apparatus of claim 1 further including communication security logic operative to allow the communication tools to securely communicate the annotated scientific-data with the communication tools in other user-configurable workspaces.

29. The apparatus of claim 1 wherein at least the user-configurable workspace is virtualized within a networked computer system.

30. A scientific collaboration apparatus, comprising:
means for communicating with a computer network,
means for configuring a workspace by a user,
a scientific information processing tool library means that includes a selection interface responsive to a user selection of ones of a plurality of scientific information processing tools that include:
one or more scientific data management tools, which are operative to manage scientific data annotated with research identifying meta-data, and
one or more scientific data communication tools, which are operative to communicate the research identifying meta-data with communication tools in other user-configurable workspaces via the communication interface, and
means responsive to user input for assembling a series of the scientific information processing tools from the scientific information processing tool library means in the workspace, wherein the means for assembling includes:
means for organizing user interface elements associated with the tools in the workspace, and
means for organizing data interfaces between selected ones of the tools.

31. A scientific collaboration method, comprising:
providing a communication interface, which is operative to communicate with a computer network,
providing a user-configurable workspace,
providing a scientific information processing tool library that includes a selection interface responsive to a user selection of ones of a plurality of scientific information processing tools that include:
one or more scientific data management tools, which are operative to manage scientific data annotated with research identifying meta-data, and
one or more scientific data communication tools, which are operative to communicate the research identifying meta-data with communication tools in other user-configurable workspaces via the communication interface, and
providing a workspace design interface, which is responsive to user input to assemble a series of the scientific information processing tools from the scientific information processing tool library in the user-configurable workspace, wherein the workspace design interface is operative to:
organize user interface elements associated with the tools in the user-configurable workspace, and
organize data interfaces between selected ones of the tools.
